(19) United States
(12) Patent Application Publication
(10) Pub. No.: US 2007/0159109 A1
(43) Pub. Date: Jul. 12, 2007

(54) String of lights with voltage regulation

(76) Inventor: James W. Gibboney, Conyers, GA (US)

Correspondence Address: MICHAEL A. MANN;NEXSEN PRUET, LLC, POST OFFICE DRAWER 2426, COLUMBIA, SC, 29202-2426, US

(21) Appl. No.: 11/651,386

(22) Filed: Jan. 9, 2007

Related U.S. Application Data
(60) Provisional application No. 60/748,729, filed on Jan. 9, 2006.

(51) Int. Cl. H05B 37/00; F21S 4/00

(52) U.S. Cl. 315/185 S; 315/312

(57) ABSTRACT

A light string includes series-connected groups of individual lights, with each light in each group being electrically in parallel with each other and with a parallel group device that regulates voltage within the group when one of the lights fails. In an alternating current circuit, the parallel group device is preferably two back-to-back zener diodes held in a partially on status so that, in the event one of the bulbs fails, it more quickly passes current in the reverse direction, thus preventing the remaining, operating lights from experiencing a current surge.

### CROSS REFERENCE TO RELATED PATENTS

The priority benefit of U.S. provisional application Ser. No. 60/748729, filed Jan. 9, 2006, is claimed.

### BACKGROUND OF THE INVENTION

The present invention relates generally to strings of lights such as those used for decorating Christmas trees.

Strings of lights, that is, plural lights wired together to be powered from a plug inserted into a wall outlet, are used to decorate Christmas trees and homes. They are used for both interior decorating and exterior decorating.

For a 100-lamp light set, there are typically two types: two series circuits and three series circuits. The light sets both work the same, but the difference between the two is the brightness. One type is normal brightness and the other type is referred to as “super” bright. The difference in lamp brightness is attributable to the lamp voltage. The two series circuits have a lower lamp voltage per lamp (2.5V) i.e. 125/50. Each series circuit has 50 lamps.

The three circuit set has a higher per-lamp voltage of (3.5V) i.e. 125/35, for a much higher voltage and brighter lamp. Each circuit has 35 lamps in it. This means that a “super bright” 100-light set actually has 105 lamps in it.

Lamps in these sets can fail for a number of reasons. Typically lamp filaments can burn out. Bulbs can break. Lamps can also become loose and fall out or be pulled out by vandals. The contacts can corrode. While some of these events can be mitigated to some limited extent, none can be prevented. And now with the advent and popularity of pre-lighted artificial Christmas trees, having a light string that continues to operate safely even in the event one or more of the lamps fails is an important goal.

### SUMMARY OF THE INVENTION

The present invention is a string of lights comprising plural groups of lights, each light in each group being electrically in parallel with each other light in the same group, each group of lights being electrically in series with each other group. Importantly, in each group of lights and electrically in parallel with each other light in the group is a device that controls the lights in that group. This device can control the group in several ways. In at least one of those ways, it allows the current to flow across that group from the previous group to the next one without shorting the balance of the light string in the event that one or more of the lights in that group is removed or burns out. In another way, it can be programmed to turn out the lights in that group in a programmed sequence, whether random or otherwise, or on command in response to a remotely transmitted signal.

A particular embodiment of the present invention is a series of groups of lamps, with each lamp in each group arranged electrically in parallel with each other lamp in that group and with a voltage regulator, preferably a pair of back-to-back zener diodes, electrically in parallel with the lamps of the group. The zener diodes regulate voltage in the group, particularly when one of the lamps fails. Importantly, the zener diodes are kept in a partially-turned-on mode so that, when one of the lamps burns out or is removed, it can more quickly act to regulate the current flowing in the remaining bulbs, thus limiting the otherwise inevitable surge of electrical current to the other bulbs.

Another feature of the present invention is that the use of a device in each group of lights makes it easier to determine which bulb is missing or burned out because the remaining lights will continue to light.

Yet another feature of the present invention is the incorporation of a device in each group that can control the current flow in that group for different purposes, depending on the choice of the user, including decorative effects.

These and other features and their advantages will become apparent to those skilled in the art of the manufacturing and use of strings of lights from a careful reading of the Detailed Description of Preferred Embodiments, accompanied by the drawings.

### BRIEF DESCRIPTION OF THE INVENTION

In the drawings,

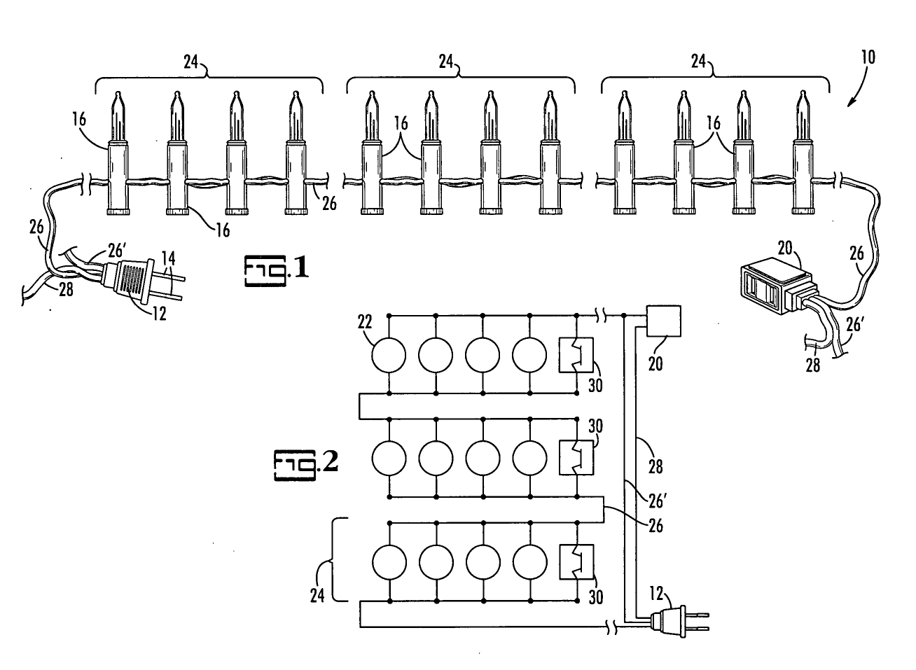

FIG. 1 is a perspective view of a section of a string of lights, according to a preferred embodiment of the present invention; and

FIG. 2 is a schematic view of an electrical circuit for a string of lights, according to a preferred embodiment of the present invention.

### DETAILED DESCRIPTION OF PREFERRED EMBODIMENTS

The present invention is a string of lights such as might be used to decorate a Christmas tree. In the preferred embodiments described below, the present invention will be illustrated as a Christmas tree light string using smaller “mini” lights but it will be clear that larger or smaller lights can be used and that the present invention can be a light string used in other applications.

A “string of lights” means a plurality of lights all of which are in electrical connection with each other and a plug so that, when the plug is connected to a source of electricity, lights along the string light up. “Light” or “lamp” will be used herein to refer to the individual light in the series, including its bulb, base and socket with the sockets internal connections.

Referring now to FIGS. 1 and 2, there is illustrated a preferred embodiment of the present invention in perspective and schematic form, respectively. A light string 10 includes a plug 12 having two terminals 14 that are insertable into a wall socket (not shown) or other source of alternating electrical current and plural lights 16 that are physically and electrically connected by wires 18. String 10 terminates in a female plug 20 that can receive another plug 12 from another string of lights when the user wishes to have two strings draw electrical current from the same outlet.

Each light 16 includes a socket 20 and a bulb 22. Lights 16 are arranged in groups 24 and the groups connected together. As illustrated, there four lights 16 in a group 24.

Running between each light 16 in a group 24 are two wires 18; from lights 16 of one group 24 to lights 16 of another group 24 there is one wire 18. Note that there is a return wire 18 running from plug 12 to female plug 20. Except for the variation in the number of wires running from one light 16 to the next light 16, there is no difference between string 10 and the prior art light strings.

FIG. 2, in addition to showing the basic arrangement of lights 16, wires 18, groups 24 and plugs 12 and 20, also illustrates a parallel group device 30 connected electrically in parallel with each light 16 in a group 24. The arrangement of light string 10 into groups 24 and its function including that of parallel group device 30 is disclosed and described in PCT/US99/09984, which is incorporated herein in its entirety by reference.

In one embodiment, parallel group device 30 is composed of an integrated circuit comprised of multiple semiconductor junctions cascaded in a series fashion, or, alternatively, of a bipolar device; the number of semiconductor junctions is determined by the lamp voltage. If a bulb 22 burns out, its contacts degrade or it is removed from the group 24, the voltage drop across the remainder of the group 24 changes slightly because of the increased current flow across the remaining lamps and because of the voltage drop due to the resistance of the wire itself.

By using PN junction semiconductors or custom bipolar devices, which have voltage drops across them of a magnitude that depends on the design and material of which the semiconductors are made, a device 30 can be constructed that is pre-programmed to regulate the current flowing through, and the voltage drop across, group 24 so that it does not exceed a particular level and remains constant no matter what happens to an individual bulb 22.

For use in regulating lamps receiving alternating current (AC), device 30 is preferably a pair of zener diodes arranged in back-to-back orientation. The voltage of the circuit determines how many groups there are. For example, if the voltage is 120 VAC, and the lamps are rated at 5 volts rms (root mean squared), there would be 24 groups. There would be at least two lamps in each group with the total number of lamps limited by the current the circuit was designed to draw.

The group is designed so that a small current passes through the zener diodes at all times, which is characterized as a “partially turned on” state. This state allows them to respond as a rapid voltage regulator.

Zener diodes characteristically have a sharp turnover or breakdown reverse voltage curve, which is available from the manufacturer. However, at the start of this curve, there is a narrow region that is relativity flat wherein they can operate but that is not a fully turned on state, but rather a partially turned on state. If a zener diode is operated in this part of the characteristic curve, no breakdown will occur, however a small leakage current flows, indicating proximity to the breakdown or avalanche point. Operating the zener in this region and deliberately keeping it there during normal operation uses a little more power then when the zener diode is kept out of this region, however the response time in the event of a bulb failure is considerably shortened as the zener diodes quickly move from the partially turned on state to the fully on state. The shorter the response time of the back-to-back zener diodes, the more limited is the current surge in the remaining lamps upon the failure of any one lamp in the group.

The parallel lamp groups, being electrically connected in a series, act as a voltage divider network. This network becomes a constant current, constant voltage, multi-element, compound circuit. The parallel structure within groups means that the lamps cannot have shunts, wherein, in normal series-connected miniature light sets, all lamps have shunts in order to keep current flowing throughout the series network in the event of a filament failure. In this parallel lamp configuration, the lamps can fail for any reason, i.e. bad filament, broken or leaky bulb, corrosion of the electrical contacts, broken or skewed Dumet wires, or lamp missing altogether; the last six of these failure modes extinguish a normal series connected light set, however the parallel group configuration as presently described, continues to light the remaining lamps when one or more of the aforementioned failure modes occurs. Due to the fact that this is a complex, multi-element, parallel/series network, the loss of one or more lamps in a parallel group will cause a change in current flow. This current flow increases across the affected group, therefore increasing the voltage drop across the affected group. This voltage increase pushes the zener diodes almost instantly into the breakover region of their characteristic curve and they immediately begin to regulate the voltage in that group by passing current enough to restore the current level in the balance of the network. This helps to keeps the lamps at a constant voltage, thus extending their life considerably.

In another embodiment using conventional alternating current, device 30 can be formed of six diodes, three in each direction.

In another embodiment, a multi-junction, application-specific integrated circuit (ASIC) could be used that would functionally imitate the series of diodes. The integrated circuit could be a discrete component containing a PN-PN-PN-PN junction or a custom bipolar junction. It will be clear to those skilled in the art of integrated circuit fabrication that a multi-junction containing these specifications could be made without undue experimentation.

For use with a DC, such as that supplied by an electrical plug as described in U.S. Pat. No. 5,777,868, which is incorporated herein by reference, this device 30 can comprise two silica diodes, each with a 1.1 volt forward voltage drop separated by a Zener diode with a 0.7 forward voltage drop for a 2.9 volt total, nearly matching but slightly less (i.e., about 0.1 volt or less) that the three volt drop across the lights.

The configuration of the parallel group device 30 assures that the voltage drop across the group 24 is always approximately three volts regardless of the number of bulbs missing, burned out, or whose contacts are degraded. If a lamp 22 is removed, for example, and the current rises, the reverse bias of the Zener diode is overcome. When it breaks down, it begins to conduct, thus in effect replacing the missing bulb. Preferably, the Zener diode does not have a sharp threshold for breaking down and can be selected to smoothly (but quickly) begin passing current. Likewise, a custom bipolar device could be fashioned to produce like results.

It will be apparent to those skilled in the art of electrical light strings that many substitutions and modifications can be made to the preferred embodiments described above without departing from the spirit and scope of the present invention, which is defined by the appended claims.

What is claimed is:

1. A string of lights, comprising:
plural groups of lights, each group of lights in said plural groups being electrically in series with each other group of lights in said string of lights, said each group including plural lights, each lights in said said each group being electrically in parallel with said each other light in said each group; and
means for regulating voltage of said each light in said each group.

2. The string of lights as recited in claim 1, wherein said voltage regulating means is two zener diodes.

3. The string of lights as recited in claim 2, wherein said two zener diodes are arranged back to back.

4. The string of lights as recited in claim 3, wherein said two zener diodes are selected to operate in a partially turned on state when said each other light in said each group is functioning and to operate in a fully on state when at least one of said each other lights in said each group fails.

5. The string of lights as recited in claim 1, wherein said voltage regulating means is an integrated circuit adapted to pass current when at least one of said each light in said each group fails.

6. The string of lights as recited in claim 5, wherein said integrated circuit is adapted to pass current smoothly as soon as said at least one of said each other lights in said each group fails.

7. The string of lights as recited in claim 1, wherein said voltage regulating means further comprises a zener diode in series with at least one diode so that the voltage rating of said zener diode and said at least one diode is slightly less than the voltage drop across said each light in said each group.

8. The string of lights as recited in claim 1, wherein said voltage regulating means has a partially turned on state and a fully on state so that said voltage regulating means begins to move from said partially turned on state to said fully on state as soon as at least one of said said each lights begins to fail.
